(19) United States
(12) Patent Application Publication
(10) Pub. No.: US 2009/0322110 A1
(43) Pub. Date: Dec. 31, 2009

(54) HAND HOLD POCKET

(75) Inventor: PHILLIP C. RUEHL, Elm Grove, WI (US)

Correspondence Address: GODFREY & KAHN S.C., 780 NORTH WATER STREET, MILWAUKEE, WI, 53202, US

(73) Assignee: P.C. RUEHL ENGINEERING, INC., ELM GROVE, WI (US)

(21) Appl. No.: 12/410,583

(22) Filed: Mar. 25, 2009

Related U.S. Application Data
(60) Provisional application No. 61/039,617, filed on Mar. 26, 2008.

(51) Int. Cl. B60J 9/00

(52) U.S. Cl. 296/1.02

(57) ABSTRACT

A pocket mounts just below a trailer's rear door to securely anchor a post. This mounting provides a solid three or four-point-contact when climbing into a trailer. A second pocket mounted to the inside of the trailer door provides easy and convenient storage. The handle-post may simply be lifted from one pocket, and dropped into the other, thus clearing passage for the door swing, while storing the handle post right at the point-of-use.

### CROSS-REFERENCE TO RELATED APPLICATION

This application is based on and claims priority from U.S. Provisional Patent Application Ser. No. 61/039,617, filed on Mar. 26, 2008, which is incorporated herein by reference for all purposes.

### FIELD OF THE INVENTION

The present invention is directed generally to accessories for accessing a vehicle such as a tractor, trailer or truck.

### BACKGROUND OF THE INVENTION

There are about five to six million semi-trailers in use in the U.S., and a similar number of Class 5, 6, and 7 straight rail medium and heavy trucks, and class 8 tractors. These tractors, trucks and trailers are produced by several domestic and foreign truck manufacturers, and each manufacturer typically offers multiple models and styles. Despite the large number of tractors and trucks in use and the wide variety of models and styles available, virtually all of the trailers and most of the trucks have an elevated bed that can be difficult to access. The trailer floor is typically about 50 inches above the ground. Even with any type of add-on step alone, the climb is difficult because there is nothing to hold onto. Any permanent handle on the door itself would be out of position when the door is swung open, and if permanently mounted to the floor, would block opening of a trailer's double swinging doors.

Some trailers have a garage-type “pull-up” rear door. In that instance, if a permanent hand-hold were to be mounted to the outer side edge of the trailer's rear surface, that would still provide only a single hand hold. Both hands need separate grips to maintain an SAE-recommended three-point contact, including the user's two hands and two feet, as one releases and lifts each limb sequentially during a climb.

### BRIEF DESCRIPTION OF THE DRAWINGS

FIG. 1 is a top plan view of a stamping blank prepared to make a hand hold pocket according to a preferred embodiment of the invention.

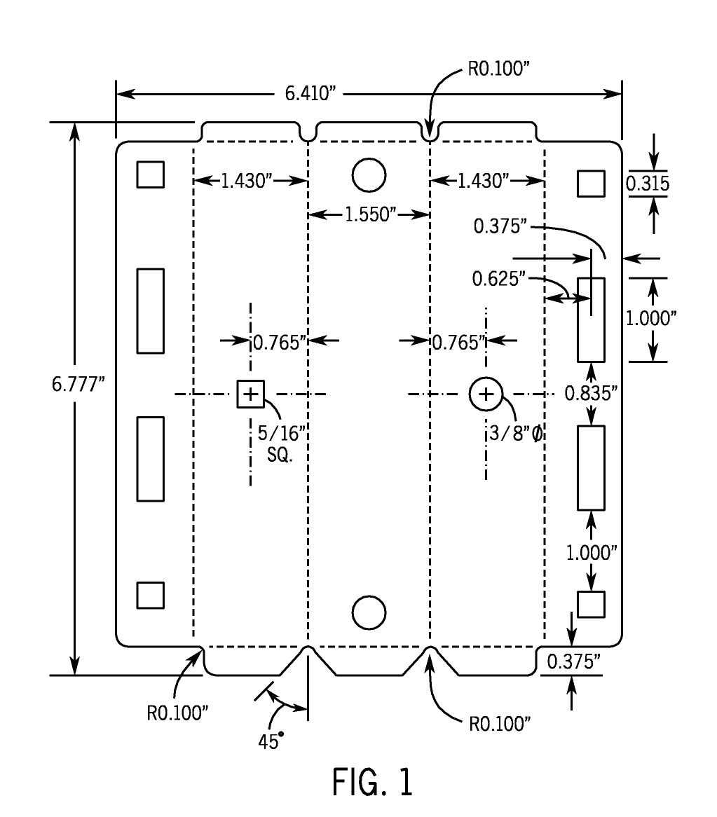

FIG. 2 is a side elevational view of the finished hand hold pocket shown in FIG. 1, after having been formed.

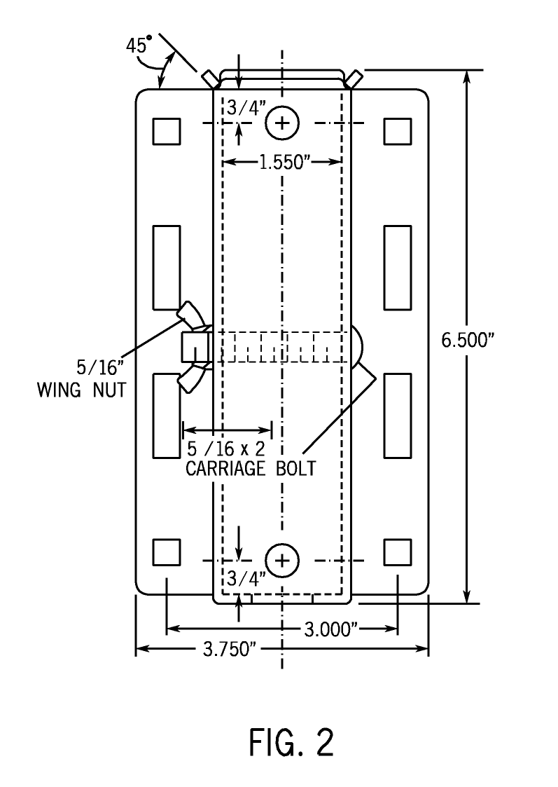

FIG. 3 is a side elevational view of the hand hold pocket shown in FIG. 1, after having been formed, taken rotated 90 degrees from the view shown in FIG. 2.

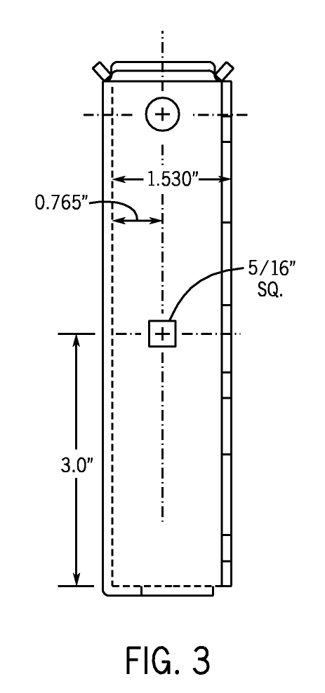

### DETAILED DESCRIPTION OF THE INVENTION

According to the invention, a pocket, formed as shown in the drawing figures, mounts just below a trailer's rear door to securely anchor any 1-½″ round or square handle-post. This mounting provides a solid three or four-point-contact when climbing into a trailer. A second pocket mounted to the inside of the trailer door provides easy and convenient storage. The handle-post may simply be lifted from one pocket, and dropped into the other, thus clearing passage for the door swing, while storing the handle post right at the point-of-use. Two pairs of pockets about two feet apart would provide left and right hand grips. They also fit along the sides of a flat bed, or on the truck frame siderail at the fifth wheel platform.

For extra security, a carriage bolt passing from left to right through respective holes in the sides of the pocket and of the handle post, with a wing nut, would prevent unintended lifting during use, or any potential bouncing out of the storage pocket when driving off-road or over deep potholes in pavement.

What is claimed is:

1. A hand hold pocket for application to a truck, tractor or trailer (or any similar need) substantially as shown and described.
